(19) United States
(12) Patent Application Publication
(10) Pub. No.: US 2009/0327849 A1
(43) Pub. Date: Dec. 31, 2009

(54) Link Classification and Filtering

(75) Inventors: Zentaro K. Kavanagh, Bellevue, WA (US); Charles F. McColgan, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,534

(22) Filed: Jun. 27, 2008

(51) Int. Cl. G06F 17/00

(52) U.S. Cl. 715/205

(57) ABSTRACT

A system for classifying links may be used for filtering email messages and other content. Links may be classified by many methods, including analyzing registration databases and cached or actual resources referenced by the links. Using registration data, a link may be classified based on the registrar, registrant, and the date of registration. The resource referenced by the link may be analyzed using keywords as well as incoming and outgoing links to the reference. Once classified, the link may be used to classify email messages and web content for unwanted advertisement, pornography, malicious software, phishing, or other classifications.

### BACKGROUND

Links to various websites and resources can be found in websites and email messages, as well as other locations. In some cases, links can be used to identify email messages or websites that may be merely annoying, such as spam email, or potentially harmful such as links that contain malicious software or other harmful or offensive content such as pornography. One form of a potentially harmful email message is a phishing message that may attempt to fraudulently lure a recipient to disclose personal information such as credit card or bank account information.

Purveyors of unwanted solicitations or phishing messages tend to send out thousands if not millions of email messages in a single campaign. In many cases, such email messages may include links to a website or other location where a user may make a purchase. In some cases, the links may direct a user to a website where malicious software may be installed on a user's device without the user knowing.

### SUMMARY

A system for classifying links may be used for filtering email messages and other content. Links may be classified by many methods, including analyzing registration databases and cached or actual resources referenced by the links. Using registration data, a link may be classified based on the registrar, registrant, and the date of registration. The resource referenced by the link may be analyzed using keywords as well as incoming and outgoing links to the reference. Once classified, the link may be used to classify email messages and web content for unwanted advertisement, pornography, malicious software, phishing, or other classifications.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with link classification.

FIG. 2 is a flowchart illustration of an embodiment of a method for classifying an email message.

FIG. 3 is a flowchart illustration of an embodiment of a method for classifying a link to a resource.

FIG. 4 is a flowchart illustration of an embodiment of a method for analyzing related links to determine a classification.

FIG. 5 is a flowchart illustration of an embodiment of a method for creating and distributing new or updated filters.

### DETAILED DESCRIPTION

Links may be used to classify an article, such as an email message or a website. The classification may be used to permit or deny access to the article, or may be used to access the resource identified by the link in a controlled manner. For example, an email message with a link to a known solicitation site may be classified as unwanted advertising. A website with a link to a pornography site may be classified as pornography.

When a link has no prior classification, a classification may be determined through analyzing the content of the linked resource, analyzing links to and from the resource, and analyzing registration database information about the link.

The content of a linked resource may be determined by retrieving the resource from a cache or by making a call to the resource. The contents may be analyzed using text analysis, image analysis, or other content analyses.

The resource may be crawled to determine incoming and outgoing links to other resources. Those links may be analyzed to determine if one or more of the links is classified. If so, the classification of the known link may be applied to the unknown link due to the relationship determined during crawling.

The link may be analyzed using registration database information. A link may be classified based on the person who registered a website or address, the registrar of the resource, and by the date of registration.

A resource may be any item that may be referenced using a Uniform Resource Identifier (URI). Some URIs may be Uniform Resource Locators (URL) that may direct a browser or other application to a website, file, streaming data source, or other object. In many cases, a resource such as a website may have many incoming and outgoing links. In some cases, a file or other data source may have several different links that may be directed to the resource.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

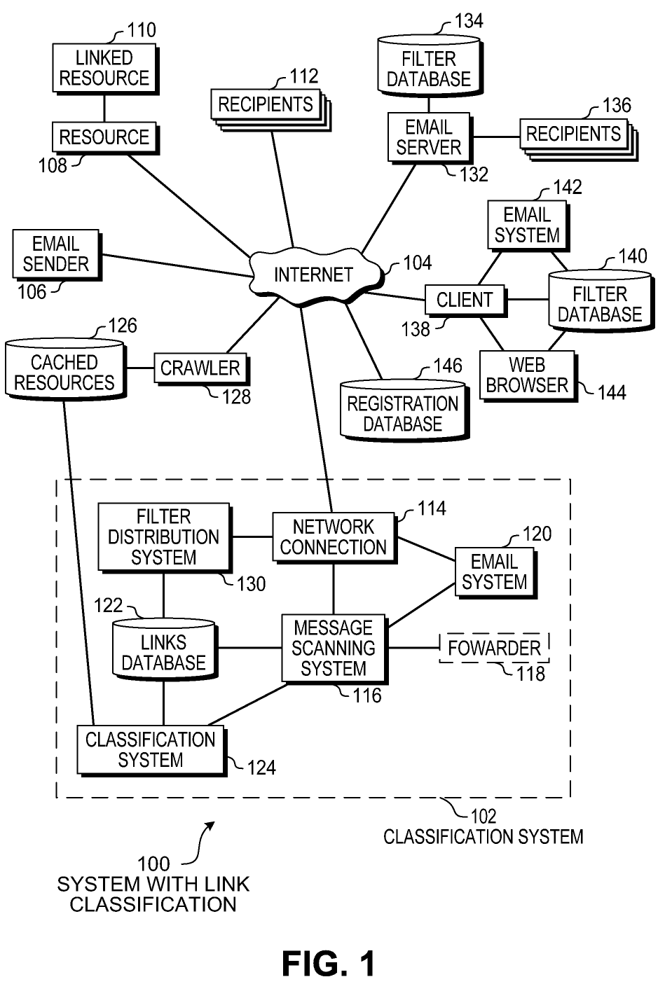

FIG. 1 is a diagram of an embodiment 100 showing a system with mechanism for classifying links to resources. Embodiment 100 is a simplified example of a network and various devices attached to the network that may perform link classification and may use the classification for various functions.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a classification system 102 that may classify email messages based on the links included in the email messages. When a link is not known to the system 102, the link may be investigated and classified. The classification mechanism may be fully automated and configured to classify a link in a very short amount of time.

The classification mechanism may classify the link based on the resource contents, links referencing the resource, links referenced by the resource, as well as information from registration databases. Some embodiments may perform one or more different types of classifications and may use multiple analyses. In some embodiments, data may be collected from various sources regarding the link and an analysis may be performed using the available data to classify a link.

A link may be a URI, URL, or URN that may be used by an application to access a resource. In many cases, a URL may be used to launch an application, web page, or other access mechanism that may access the resource. In a typical example, a resource may be a web page. A link may be a URL that may be used within a computing device to launch a web browser and display the web page.

In many cases, unknown resources may contain unwanted or malicious software or unwanted content, such as pornography, unsolicited advertisements, or other content. When a link to a resource is classified, the link may be used to identify email messages, web sites, and other content that are unwanted or potentially dangerous.

The classification system 102 in embodiment 100 may operate as a filter for large volumes of email messages. In such a use, the classification system 102 may have email messages for many different recipients routed through the classification system 102 prior to being deposited on a recipient's mailbox.

Other embodiments may have different architectures. In some cases, the function of analyzing and classifying an unknown link may be performed by a standalone server or group of server devices.

In many cases, unwanted advertising email may be sent from an email sender 106 through the internet 104 to a classification system 102 prior to being received by a recipient. When an advertising or phishing campaign in launched, the email sender 106 may send very large numbers of email messages, sometimes numbering in the millions. Each email message may contain a link to a resource 108 which may have other linked resources 110. The link in each email message may be a link to a resource 108 that, in the case of advertisements, may entice a user to make a purchase on line. In the case of a phishing message, the use may be enticed to disclose credit card or bank account information, for example.

Unwanted advertisements often have several characteristics that may be used to classify a link as unwanted advertisement. Specifically, purveyors of unwanted advertisements typically send out enormous volumes of email messages containing a link. In some cases, the email messages may be obfuscated in various manners to evade filtering. One example of such obfuscation methods may be to intentionally misspell various keywords with which an email message body may be scanned. Another example may be to embed a new link that has not yet been classified, or to configure the embedded link in a manner that may be difficult to determine the eventual resource that would be accessed if the link were followed.

The resource 108 may be any type of resource. In a typical use, a link to a resource may be accessed using a URI, which may used to connect with many different types of resources. A commonly used resource is a web page that may be accessed using an HTTP or HTTPS URI scheme. Other URI schemes may be used to access calendar information, instant messaging, television content, dictionary services, domain name services, text and voice messaging services, newsgroups, and many other types of resources.

In many cases, a URI that may be embedded in an email message, web page, or other object may have a reference or link to other linked resources 110. In a case where message sender wishes to obfuscate or hide the final destination for an unsolicited advertisement, the message sender may send a first innocuous looking URI that, when followed, leads to another linked resource 110. In some cases, two, three, or more links may be followed in sequence before a linked resource 110 is reached.

One common technique with web page addresses is to use various forwarding mechanisms. A forwarding mechanism may be any mechanism by which an incoming request for a specific URI is routed, transferred, or otherwise redirected to another URI. In some cases, a forwarding mechanism may be a static forwarding mechanism where any request is forwarded to predefined URI. In other cases, a forwarding mechanism may be a dynamic forwarding mechanism.

In a dynamic forwarding mechanism, the request for a URI may be analyzed and routed differently based on the content of the request. For example, a request for a web site that comes from a mobile telephone may be routed to a web site that has pages specifically designed for a mobile telephone. Other requests may be forwarded to different web sites designed for other devices.

In cases where dynamic forwarding is used, the classification of a given link may be strongly related to the classification of the linked resource 110. Such dynamic forwarding mechanisms may provide difficulties in determining the actual content of a linked resource 110 in some situations. For example, a dynamic forwarding mechanism may filter some devices, such as the classification system 102 and prevent the classification system 102 from accessing the linked resource 110. Such a case may occur when the address or other characteristics become known to a purveyor of unwanted advertising or malicious software. In such a case, the purveyor may direct requests from the classification system 102 to a resource that appears legitimate and innocuous, but may redirect the intended message recipient to a resource for selling products, pornography, phishing, or a resource that contains malicious code, for example.

When attempting to classify a link, the classification system 102 may attempt to connect to the resource 108 to analyze the resource contents. When a dynamic forwarding mechanism is employed, the classification system 102 may be deceived if the forwarding mechanism redirects the classification system 102 to an innocuous resource but redirects a targeted recipient to a dangerous or undesirable resource. In such cases, the classification system 102 may attempt to disguise a request for a resource 108 in various manners to defeat a dynamic forwarding mechanism.

One use for a classification system 102 may be to receive, analyze, and forward email messages directed at various recipients 112. In some cases, the classification system may queue or store messages and perform additional email or message management functions. In such embodiments, email messages intended for the recipients 112 may be forwarded to the classification system 102 prior to being stored in a mailbox or other storage system.

In some embodiments, the classification system 102 may be designed to handle large volumes of email messages, such as the email messages for an entire corporation or even many large corporations. Such systems may handle many millions of email messages per day. In many such large deployments, the classification system 102 may be capable of detecting new, unclassified links within email messages and performing a classification procedure so that subsequent email messages containing the new links may be appropriately filtered or handled.

The classification system 102 may contain a network interface 114 through which the classification system 102 may communicate with the Internet 104. In many embodiments, the network interface 114 may connect to a local area network that may in turn be connected to the Internet. In some embodiments, the network interface 114 may connect to a local area network that may not have access or connection to the Internet.

Incoming messages to the classification system 104 may pass through a message scanning system 116 that may classify messages based on many factors, including the links contained in a message. The message scanning system 116 may look up a link in a links database 122 to determine if the link has been classified, and may use the link classification to determine a classification of the incoming message. The message may be transferred to a forwarder 118 for forwarding to the recipients 112 or may be stored in an email system 120 for later retrieval by the recipients 112.

The forwarder 118 may forward or transmit a scanned email message to a recipient 112 or may forward the message to an email server 132, which may in turn make the message available to various recipients 136.

The email system 120 and email server 132 may host mailboxes that contain email messages and other data. The respective recipients 112 and 136 may access the mailboxes and retrieve messages and perform other tasks, such as forwarding, replying, storing, deleting, and other manipulation of the messages.

When a message is scanned by the scanning system 116 and a link is detected that is not previously classified or known in the links database 122, a classification system 124 may attempt to classify the link. The classification system 124 may use many different methods independently or in conjunction with each other to determine a classification for the link. After determining a classification, the links database 122 may be updated.

The classification system 124 may analyze a link by analyzing the content of the linked resource, other links to and from the resource, as well as information about the registration of the resource or related objects. The classification system 124 may use one or more of the methods for classification and may combine various pieces of information to generate a classification score, in some embodiments.

The classification system 124 may analyze the content of a linked resource. The classification system 124 may obtain the content of the linked resource by either connecting to the resource 108 and retrieving the resource itself, or by analyzing a cached version of the resource using cached resources 126. The cached resources 126 may include a copy of various resources available on the Internet 104 as retrieved by a crawler 128. The crawler 128 may crawl the Internet 104 and send back copies of any resources the crawler 128 may find. In such cases, the cached resources 126 may become a copy of the content available on the Internet 104.

When a cached version of a resource is available, the classification system 124 may prefer a cached version over connecting to the actual resource 108 through the Internet 104. A cached version may be accessible without network or server latencies and may also enable analysis of the link without having to request the resource. When a request is made, a host device for a resource may be able to recognize that the request is being made from a classification system 124 and may redirect the request to a different linked resource 110 than would be retrieved by an intended recipient of an email message.

In such a case, the classification system 124 may be able to create a request for a resource that tricks the host device for a resource into allowing the classification system 124 to retrieve the actual linked resource 110. Such mechanisms may include identification masquerading where the classification system 124 assumes a different identification or address. Such mechanisms may involve routing a request through a proxy server so that the request appears to be sent from the proxy server and not the classification system 124.

A resource 108 may be classified by the contents of the resource. Such classification may be performed by searching for specific keywords. For example, many unwanted advertisements are for pharmaceuticals. A resource may be classified as a pharmaceutical site if one or more drug names are found, for example. Other resources may contain pornography. Such resources may be identified by analyzing the text, image, or other content of the resource for pornographic related items.

In many cases, a link to a resource may be classified based on other links or resources that have a relationship to the first link. Such relationships may be determined by crawling the resource 108 to determine inbound links to the resource 108 as well as outbound links from the resource 108. In some embodiments, the inbound or outbound links may be crawled two, three, or more steps to determine various other resources with a relationship to the original link.

In some embodiments, the cached resources 126 may be a very large database, such as a database that replicates the Internet 104. Such databases may be used by search engines for performing various types of searches for the Internet 104. Various crawlers 128 may be used to continually update and refresh the cached resources 126.

A classification may be determined by analyzing the related links, their resources, and the relationships between the links. In a simple example, if a new, unclassified link to a resource 108 is found to link to a linked resource 110 that is a pornography website, the new link may be classified as pornography without having to examine the contents of the linked pornographic website.

In many cases, a resource 108 may be referenced by several other links. The resource 108 may be a website and the links to the resource 108 may each have different parameters or slightly different path names in a URI. In such a case, a newly discovered URI may be classified in the same manner as another previously classified link that points to the same general resource.

A classification may be determined by analyzing data from a registration database 146. The registration database 146 may contain registration data, and examples of such a database include the WHOIS databases available on the Internet 104. The registration database 146 may contain various information including the registrant of a resource, the registrar that accepted the registration, and the date and time of registration.

The registrant of a resource may be an indicator that may be used for classifying a link to a resource. The registrant may be a person or corporation in whose name the registration is held. As resources are classified, the registrants of those resources may be assigned a similar classification. For example, a known seller of pharmaceuticals may have many different websites. When a link to a new website resource is found to have the same registrant as the known seller, the link may be classified as a pharmaceutical website.

Similarly, the registrar associated with a resource may give an indication for the type of resource. The registrar is an agency, company, or other organization that may be granted authority to accept registrations and assign domain names and other resources. Purveyors of unsolicited advertisements often register resources with certain foreign registrars with high regularity.

The date and time of registration may also give some indication about the legitimacy of a resource. In some unwanted advertisement campaigns or phishing expeditions, a website may be quickly set up and email messages sent en masse to various recipients. Legitimate websites or other resources often have been registered for many years.

Each piece of data that may be obtained from a registration database 146 may be combined to yield a probability or score for classification purposes. Some factors may be more relevant than others in determining a classification, and different weighting may be applied to each factor. Such classification may also include factors based on the incoming and outgoing links, along with factors determined from the content of the linked resource or content from resources linked to the original resource.

In some embodiments, many different types of classification may be defined. For example, a link may be classified as unwanted advertisement, pornography, malicious software, or any other classification. In some embodiments, a classification may be defined that is either legitimate (good) or illegitimate (bad). Some embodiments may use a rating or graduated scale that may define good as 100 and bad as 0. As various factors are examined for a specific link, a link may be classified as a number between 100 and 0. The algorithms, formulas, or other mechanisms that may be used to determine such a graduated classification mechanism may vary greatly from one embodiment to another.

In some cases, a company or administrator may define a custom algorithm for different applications. For example, a company that has a policy of very limited web surfing on company computers may permit business related sites and may severely limit access to non-business related sites. A college campus may allow much wider access but may wish to limit access to unwanted advertising, malicious software, and phishing. Each embodiment may have different mechanisms for enabling definition or modification of a classification algorithm.

In some embodiments, the classification system 124 may classify links and store the classifications in a links database 122. The links database 122 may be used by the message scanning system 116 to filter email messages.

The links database 122 may also be used to generate filters by a filter distribution system 130. The filters may contain classification information from the links database 122 may be used for filtering email messages along with other applications, such as web browsing.

The filter distribution system 130 may create a new or updated filter based on changes to the links database 122. The filter distribution system 130 may then distribute the filter to an email server 132, where the updated or new filter may be stored in a filter database 134. The email server 132 may process incoming and outgoing email messages using the filter database. The email server 132 may permit or deny access to messages based on the filters, or may handle some messages differently than others based on the message classification, which may be based at least in part on the classification of any embedded links. The email server 132 may be configured to provide mailboxes and other services for the recipients 316.

In some embodiments, the filter distribution system 130 may distribute filter information to a client device 138, which may store the filter information in a filter database 140. The client device 138 may use the filter database 140 for analyzing incoming and outgoing email messages with a local email system 142. The email system 142 may, in some cases, be an application by which a user may read, create, browse, and interact with email messages.

The filter database 140 may also be used to filter content viewed with a web browser 144. The filter database 140 may contain classifications for various links for resources. As a user browses from one location to another using the web browser 144, the content of the resources being browsed may be permitted, denied, warned, or handled in different manners based on the link classification.

Embodiment 100 is merely one example of a system that may perform some classification of links. Embodiment 100 illustrates a system that may filter email messages as well as investigate and classify unknown links. In other embodiments, a classification system 124 may be a standalone system that may receive unclassified links from various sources, including email messages, web pages, documents, and any other source where a link to a resource may be encountered.

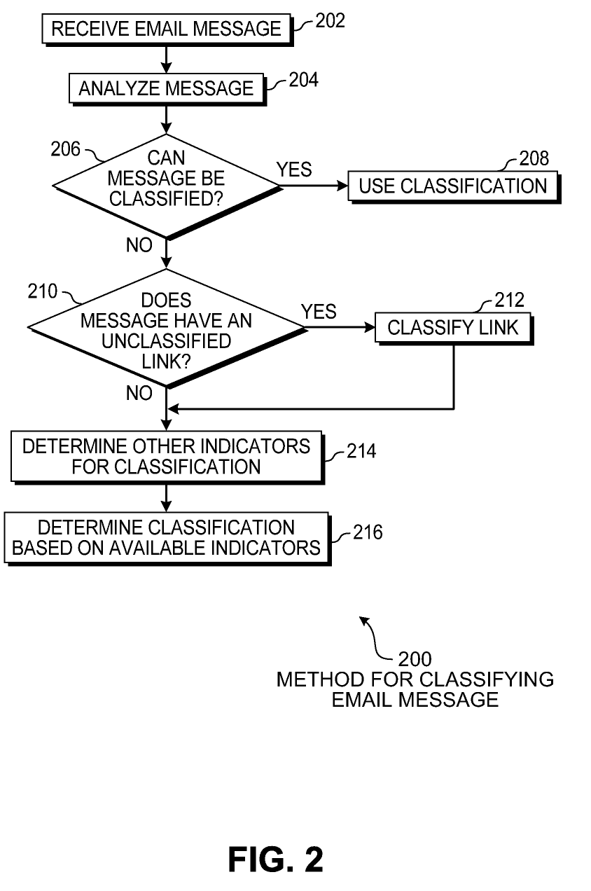

FIG. 2 is a flowchart illustration of an embodiment 200 showing a method for classifying an email message. Embodiment 200 is a simplified example of a sequence that may be performed by an email message scanning system 116. Embodiment 200 is a general process for classifying an email message that may contain an embedded link.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

An email message may be received in block 202 and may be analyzed in block 204.

The analysis of block 204 may be any type of analysis that may be used to classify the message. Such analysis may include analyzing the sender and recipient addresses, analyzing the transmission path used to send the email message, analyzing the content of the email message, or any other analysis. The analysis of block 204 may also include analyzing any links that may be embedded in the email message.

If the message may be classified in block 206 using the analysis of block 204, the classification may be applied in block 208 and the process may terminate.

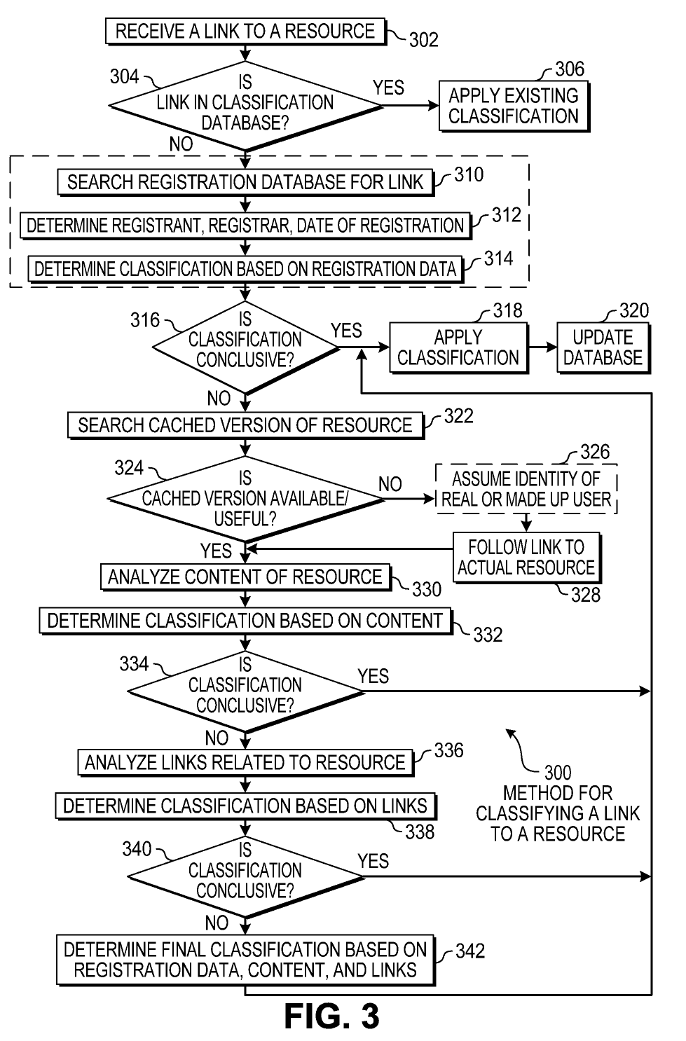

If the message cannot be classified in block 206 using the analysis in block 204, the process may continue to block 206. If the message contains unclassified links in block 210, the link may be classified in block 212. An example of a method for classifying links may be found in embodiment 300 illustrated in FIG. 3 of this specification.

After classifying the link in block 212, or if no unclassified links exist in the message in block 210, other indicators may be determined for classification in block 214. The other indicators may include more detailed analysis of the message content.

In some embodiments, the analysis of blocks 204 or 214 may include analyses of multiple email messages. Such analyses may identify patterns of repetitive email messages or messages that share similar content, metadata, or other elements. Such analyses may be performed over multiple messages transmitted to the same or different recipients and sent by the same or different senders.

Using the available data, a classification may be determined in block 216.

Once a classification is determined, various policies or procedures may be defined for handling a classified message. For example, a message that may contain questionable or potentially dangerous content may be displayed with the links disabled, with a red warning message, or with some other active or passive indicator. Some such messages may have the content suppressed such that a user may not be able to view or retrieve the message. In some cases, an email message with a specific classification may be stored in a different folder, for example. In some cases, certain messages may generate an alert that may be transmitted to an administrator, such as if a virus or other malicious software was detected.

FIG. 3 is a flowchart illustration of an embodiment 300 showing a method for classifying a link to a resource. Embodiment 300 is a simplified example of a sequence that may be performed by a classification system 124 and may be represented by block 212 of embodiment 200. Embodiment 300 is a general process for classifying a link using registration data analysis, linked resource content analysis, as well as analysis of related links.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A link to a resource may be received in block 302. In embodiments 100 and 200, an unclassified link may be detected through an email message. In other embodiments, an unclassified link may be detected through a web browser or any other application that may use links such as URI to communicate with various resources.

If the link is in the classification database in block 304, the classification from the database may be applied in block 306. The link may be classified in block 306 and the process may end.

If the link is not in the classification database in block 304, a registration data analysis may be performed in block 308. The registration data analysis of block 308 may include searching a registration database for the link in block 310.

In some cases, a portion of a link may be used to perform a search of a registration database. For example, a URI link of the form http://server.example.com/testpage.html:8042;type=animal?name=ferret may be presented. The registration database may be searched using example.com to determine the registrant, registrar, and date of registration in block 312.

Based on the data returned in block 312, a classification may be determined in block 314.

If the classification is conclusive in block 316, the classification may be applied in block 318 and the links database may be updated in block 320.

If the classification is not conclusive in block 316, a search may be performed in block 322 for a cached version of the resource. If the cached version of the resource is available and useful in block 324, an analysis of the content may be performed in block 330. If the cached version of the resource is not available in block 324, an identity may be assumed of a real or hypothetical user in block 326 and the link may be followed in block 328 to retrieve the resource.

In many cases, a cached version of a resource may be preferred as in block 322 rather than a version that is retrieved on demand, as in block 328. The cached version may be much faster to retrieve in some cases. In a case where an initial link may be forwarded to another link, the retrieval time may have a large amount of latency. Further, a query to the link may be diverted to a different location when a classification system attempts to access the resource.

A cached version of a resource may be obtained from a database that contains copies of the various resources available on the Internet. One example of such a database may be the databases used by search engines. Due to the side of the Internet, such copies may be massive in scale.

In some instances, a subset of resources may be periodically copied and stored as a cached set of resources. Such a subset may be those resources that may be identified as potentially useful when classifying links. For example, a database may be specially tailored to contain resources related to known purveyors of unwanted advertising or those who deal in illicit or pornographic materials.

The content of the resource may be analyzed in block 330. The content may be analyzed in many different manners. In a simple example, the content may be searched for keywords that may be previously classified. In more detailed analysis, images or other media within the resource may be analyzed to determine a classification.

A classification attempt may be made in block 332 based on the content of the resource. If the classification is conclusive in block 334, the process may proceed to block 318 where the classification may be applied to the link and the database may be updated in block 320.

In some embodiments, the conclusiveness of the classification in block 334 may take into account any factors that may exist with respect to classification. For example, in block 334, the content of the resource as well as the registration data from block 308 may be combined to determine if the classification is conclusive.

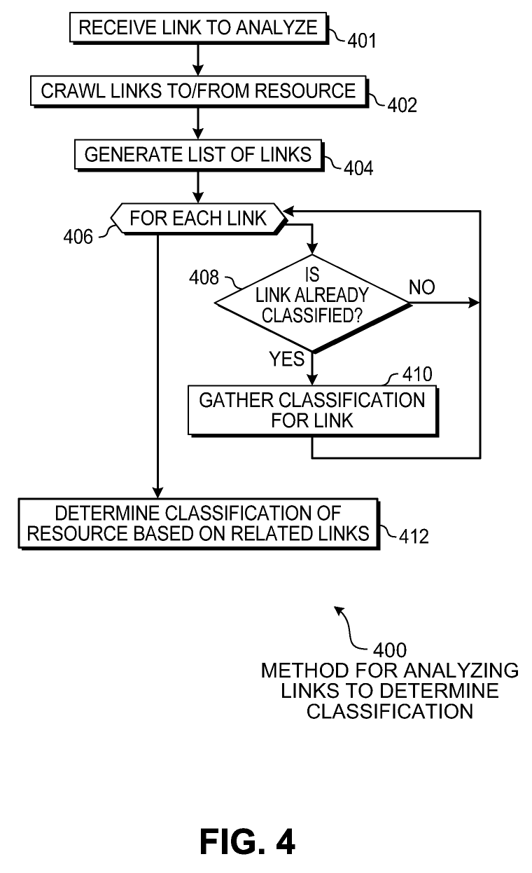

If the classification is not conclusive in block 334, the links related to the resource may be analyzed in block 336. An example of such an analysis may be illustrated by embodiment 400 in FIG. 4, presented later in this specification.

A classification may be determined in block 338 based on the links related to the resource. If the classification is conclusive in block 340, the process may proceed to block 318. If the classification is not conclusive in block 340, a final classification may be determined in block 342 using registration data, content analysis, and links analysis. The process may then proceed to block 318.

FIG. 4 is a flowchart illustration of an embodiment 400 showing a method to determine a classification for a first link based on related links. Embodiment 400 is a simplified example of a general process that may be performed in blocks 336 and 338 of embodiment 300. Embodiment 400 may also be performed as part of other processes for analyzing and classifying links.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A link may be received to analyze in block 401. The link may refer to a resource, and the resource may be crawled in block 402 to determine related links. In many cases, incoming and outgoing links to the resource may be identified. In some cases, the crawling of block 402 may traverse many links in several steps.

A list of links may be generated in block 404. The list of links may include relationships between the original link of block 401 and the links discovered during crawling in block 402.

Each link in the list of block 404 may be analyzed in block 406. If the link is not already classified in block 408, the next link is analyzed. If the link is classified in block 408, the classification information for the link is gathered in block 410.

After processing all of the links in block 406, a classification of the initial link may be determined based on any classification information obtained from related links.

In a typical website resource, a link into the website may reference a resource of a web page. The web page may include outgoing links to many different locations. Some of the locations may be internal to the website and other locations may be external to the website. As those links are crawled, other web pages both internal and external to the initial resource may be located. Those web pages may also have incoming and outgoing links, which may in turn be crawled.

If any of the links that are crawled have been previously classified, that classification may be applied to the initial link. In many cases where phishing expeditions or an unwanted advertisement campaigns are performed, the purveyors may use at least one common link or element from one campaign to the next. Thus, a previously executed campaign for which a link was classified may be used to quickly identify a similar campaign that is started with a new website or other set of resources. For example, many unwanted advertisement campaigns may use a common payment processing system that may be uncovered when a new, unclassified link is crawled in block 402.

In some embodiments when a link is unclassified and the crawled links are also unclassified, one or more of the crawled resources may be analyzed by a content analysis as discussed in blocks 330 and 332 of embodiment 300.

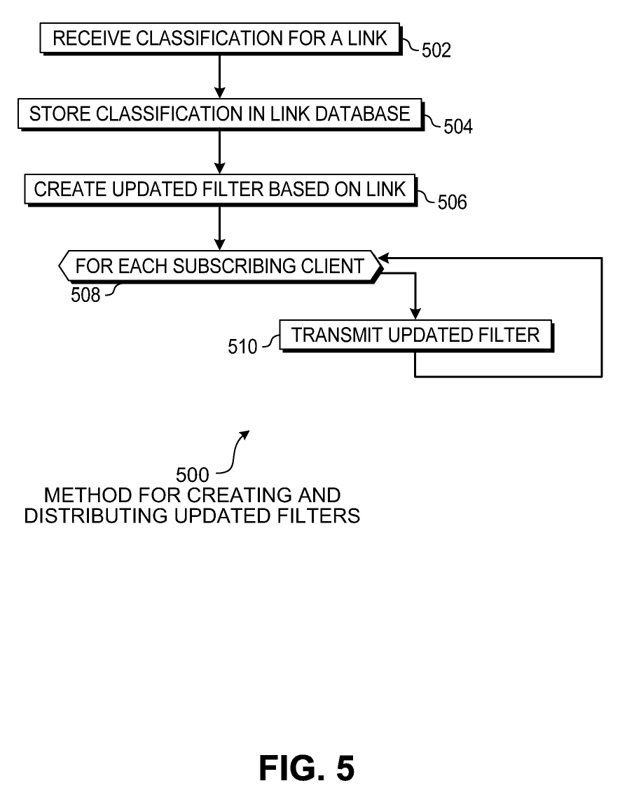

FIG. 5 is a flowchart illustration of an embodiment 500 showing a method for creating and distributing updated filters. Embodiment 500 is a simplified example of a sequence that may be performed by a filter distribution system 130.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A classification for a link may be received in block 502. The classification for a link may be a new classification assigned to a previously unclassified link or may be an updated classification to a previously classified link.

The new or updated classification may be stored in a database in block 504.

In block 506, an updated filter may be created based on the new or updated classification of block 504. Each embodiment may have different methods and mechanisms for creating a filter. In some cases, the filter of block 504 may be an update to a list of classified links.

For each subscribing client in block 508, the updated filter may be transmitted in block 510. The client may use the filter for classifying web pages, email messages, and any other connection to resources.

Embodiment 500 is an example of a method that may be performed by a system that creates filters and updates to filters, then transmits the filters to various clients. In some embodiments, the clients may pay a subscription fee for such a service, while in other embodiments, such a service may be performed without financial transactions. Embodiment 500 is an example of a ‘push’ system where the filters are transmitted to the clients without the clients first requesting the filters. Other embodiments may have a ‘pull’ system where the clients may initiate the transmission of an updated filter to the client.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a link to a resource, said link comprising a URI, and said link being an unclassified link;
classifying said link by a classification method comprising:
determining a relationship between said URI and a second link, said second link having a first classification; and
determining a second classification for said link based on said relationship and said first classification.

2. The method of claim 1, said relationship being an incoming relationship from said second link to said URI.

3. The method of claim 1, said relationship being an outgoing relationship from said URI to said second link.

4. The method of claim 3, said second link comprising a link to a payment processor.

5. The method of claim 1, said second link being determined by communicating with said resource.

6. The method of claim 1, said second link being determined by referencing a cached version of said resource.

7. The method of claim 1, said classification method further comprising:
analyzing at least a portion of content of said resource.

8. The method of claim 7, said portion of content comprising text.

9. The method of claim 1, said receiving said link being performed by a method comprising:
receiving a plurality of email messages, said email messages having at least a portion in common, said portion including said link, said email messages being addressed to different recipients.

10. A method comprising:
receiving a link to a resource, said link comprising a URI, and said link being an unclassified link;
classifying said link by a classification method comprising:
examining a portion of a registration database comprising registration data, said portion having a relationship to said link; and
classifying said link based on registration data.

11. The method of claim 10, said registration data comprising the identity of at least one of a group composed of:
a registrant;
a registrar; and
a registration date.

12. The method of claim 10, said relationship being a first order relationship.

13. The method of claim 10, said relationship being at least a second order relationship.

14. The method of claim 10, said classification method further comprising:
comparing said portion of said registration database to a database of classified registrants.

15. A system comprising:
an email message scanning system configured to receive and classify email messages directed toward a plurality of recipients;
a classification system configured to classify said email messages by a classification method comprising:
determining a link within at least one of said email messages, said link comprising a URI, said URI referring to a resource;
determining a relationship between said URI and a second link said second link having a first classification;
examining a portion of a registration database comprising registration data, said portion having a relationship to said link; and
determining a second classification for said link based on said relationship and said first classification and said registration data.

16. The system of claim 15, said classification method further comprising:
analyzing at least a portion of content associated with said link to determine a content classification, said second classification being determined at least in part by said content classification.

17. The system of claim 16, said portion of content being obtained by retrieving a portion of said resource using said link.

18. The system of claim 17, said retrieving a portion of said resource comprising transmitting a request to retrieve said resource, said request comprising at least a portion of an identity from one of said recipients.

19. The system of claim 15 further comprising:
a filter distribution system configured to create a filter based on said second classification; and
distribute said filter to a plurality of clients.

20. The system of claim 19, said filter being configured to be used by said clients for at least one of a group composed of:
filtering email messages; and
filtering web content.
